(19) United States
(12) Patent Application Publication
(10) Pub. No.: US 2008/0153455 A1
(43) Pub. Date: Jun. 26, 2008

(54) SYSTEM, METHOD AND PROGRAM FOR MANAGING VOIP CALLS SUCH AS 911 CALLS FROM MOBILE DEVICES

(75) Inventor: Thomas Alexander Lancaster, Cookeville, TN (US)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 11/613,308

(22) Filed: Dec. 20, 2006

(51) Int. Cl. H04M 11/00

(52) U.S. Cl. 455/405

(57) ABSTRACT

System, method and program product for managing VOIP calls from a mobile computing device. The mobile computing device is connected, by wire or wirelessly, to a network port device. The mobile computing device receives from the network port device information describing a geographic location of the network port device. The mobile computing device sends a VOIP call, and includes with the VOIP call, information describing the geographic location of the network port device. The VOIP call can be a 911 call or similar type of call in a country outside the USA.

### FIELD OF THE INVENTION

The present invention relates generally to computer networks and systems, and more specifically to managing VOIP calls from a mobile device, for example, managing emergency 911 calls from a mobile device and automatically identifying to an emergency response center the location of the mobile device.

### BACKGROUND OF THE INVENTION

For many years there have been telecommunications standards and hardware to support emergency calls such as “911” calls. (Note that the term “911” call references emergency type calls made in the United States by dialing “911”, but other countries use different, special telephone numbers for emergency calls. So the term “911” call references similar types of emergency calls in other countries with the respective telephone number.) A “911” call can be made from a traditional, analog telephone (whose base unit is fixed in location) by a caller pressing the 911 keypads. In response, the call is forwarded via a communication network to an emergency response center where the caller is connected to a handler. In addition, the caller's telephone number is forwarded to communications equipment in the emergency response center. At the emergency response center, the communications equipment correlates the telephone number of the caller's telephone with the state, city, street address, building, floor, etc. of the caller's telephone. The owner of the caller's telephone registered the address information (i.e. state, city, street address, building, floor, etc. where the caller's telephone is located) when the owner registered for telephone service. It is important for the emergency response center to automatically detect the location of the caller's telephone in the event the caller cannot convey the location of the caller or the actual location of the emergency (if different than the location of the caller). After determining the actual location of the emergency, an emergency response team such as a police person, ambulance or fire truck can be dispatched.

It was also known to include a GPS unit in a mobile device to relay the geographic location of the mobile device.

Many computing devices have the capability to make telephone calls over the Internet using Voice Over Internet Protocol (“VOIP”). During usage, each mobile computing device is connected to an Ethernet port, by wire or wirelessly, to connect the mobile computing device to a communications network. A person can make an emergency 911 call over the VOIP technology installed in the mobile computing device. Some computing devices such as laptop computers, PDAs, Blackberry™ devices, etc. are mobile, meaning they are commonly moved from place to place and may connect (by wire or wirelessly) to a fixed Ethernet port or other network port for access to the Internet. Each mobile device has a fixed address (typically the billing address registered when the VOIP services is initiated) even though the device may be moved anywhere in the world. The fixed or static address may be included in the 911 call made from the mobile device to an emergency dispatch center (PSAP). In such a case, the emergency dispatch center will not know the current location of the mobile device, if the mobile device is not located at the billing address. Consequently, emergency services may be dispatched to the wrong location in the event that the person placing the call is unable to speak to a handler in the emergency response center and verbally tell the handler the location of the caller and/or the location of the emergency.

In the past, Internet VOIP providers (e.g. Vonage) were not required to provide emergency services, requiring users to place emergency calls from traditional phones. However, recently, the US government mandated that VOIP providers provide emergency services, but they provide static location information which does not indicate the actual location of the mobile device if it is moved from its original location.

It was known to maintain at a central server a central database of the geographic location of each Ethernet port based on a unique port ID. When a person makes a VOIP call from a mobile computing device connected to an Ethernet port, the call goes through the Ethernet port, and the Ethernet port attaches its port ID to the call. In the case of a 911 call, communications equipment at the emergency response center receive the port ID with the 911 call, and can then query the central database at the central server to determine the location of the Ethernet port based on the port ID attached to the call. Because the mobile computing device is not far from the Ethernet port to which it is connected (even wirelessly), the emergency response center can automatically learn the location of the mobile computing device and caller. See U.S. Pat. No. 7,027,564 to James.

While the foregoing system for enabling an emergency response center to automatically learn the location of a mobile computing device making a 911 call is effective, it requires a call from the emergency response center to the central database to correlate the port ID sent by the Ethernet port to the location of the Ethernet port, and the communication lines may be down. Also, the “central database” may only be central to a single service provider and its network. Consequently, if the mobile device is moved to another network with another service provider, there may not be a central database for the mobile device to send location information to the emergency response center.

Accordingly, an object of the present invention is to enable an emergency response center to automatically learn the location of a mobile computing device making a 911 call without making a call to a central database.

### SUMMARY OF THE INVENTION

The present invention resides in a system, method and program product for managing VOIP calls from a mobile computing device. The mobile computing device is connected, by wire or wirelessly, to a network port device. The mobile computing device receives from the network port device information describing a geographic location of the network port device. The mobile computing device sends a VOIP call, and includes with the VOIP call, information describing the geographic location of the network port device. The VOIP call can be a 911 call or similar type of call in a country outside the USA.

According to a feature of the present invention, the mobile computing device can receive from the network port device the geographic location of the network port device in response to the connection of the mobile computing device to the network port device.

According to another feature of the present invention, prior to the mobile computing device being connected to the network port device, the network port device can receive from another server the information describing the geographic location of the network port device.

The present invention also resides in another method for managing VOIP calls from a mobile computing device to a first server. The mobile computing device is connected, by wire or wirelessly, to a network port device. The mobile computing device receives from the network port device information describing a geographic location of the network port device. The mobile computing device sends a VOIP call to the first server, and includes with the VOIP call, information identifying the call, the network port device and/or the mobile computing device. The mobile computing device also sends to a second server information identifying the call, the network port device and/or the mobile computing device, and information describing the geographic location of the network port device. The second server forwards to the first server the information identifying the call, the network port device and/or the mobile computing device, and the information describing the geographic location of the network port device. The first server correlates the VOIP call received from the mobile computing device with the geographic location information provided by the second server, and notifies an operator as to the geographic location of the mobile computing device.

### BRIEF DESCRIPTION OF THE FIGURES

FIG. 1 is a block diagram of a distributed computer system and network, including an enhanced Ethernet port and mobile computing device with an enhanced Ethernet port interface, according to the present invention.

FIG. 2 is a flow chart of operation and processing by the mobile computing device and enhanced Ethernet port interface of FIG. 1 during a setup phase, prior to an actual 911 call, and during an actual call.

### DETAILED DESCRIPTION OF THE PREFERRED EMBODIMENTS

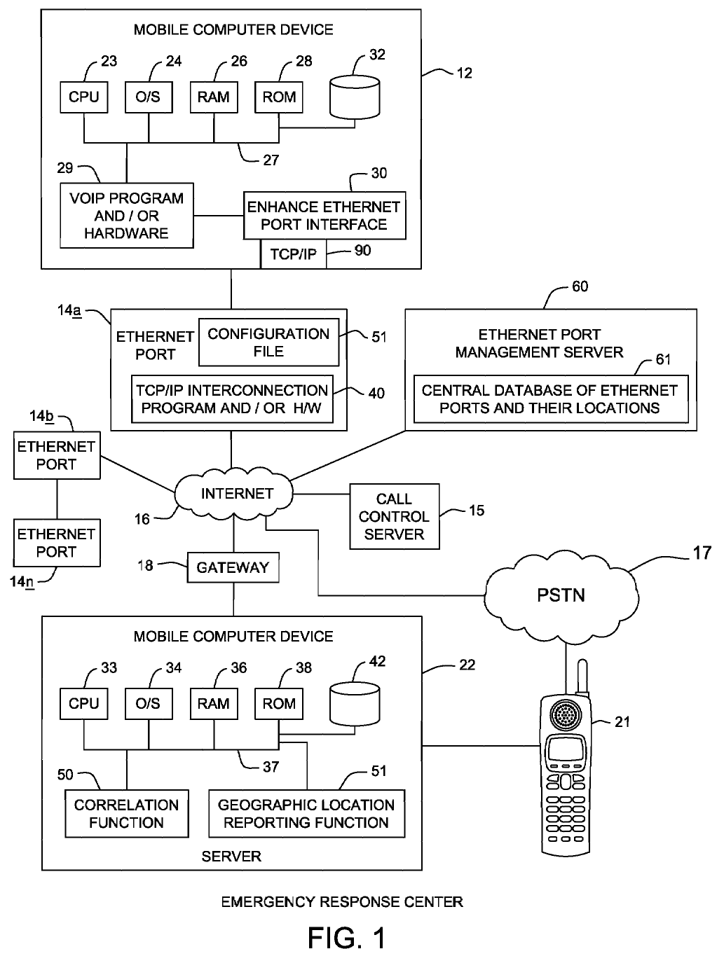

The present invention will now be described in detail with reference to the figures. FIG. 1 illustrates a distributed computer system generally designated 10 according to the present invention. System 10 comprises a mobile computing device 12 such as a laptop computer, PDA, Blackberry™ device, etc. connected (either by wire or wirelessly to an enhanced LAN switch such as an Enhanced Ethernet port 14a. Enhanced Ethernet port 14a is connected to a network 16 such as the Internet. Enhanced Ethernet port 14a communicates with various devices and networks on Internet 16, such as Ethernet Port management server 60 and gateway device 18, using TCP/IP. Enhanced Ethernet port 14a includes a known TCP/IP network interconnection function 40, implemented in computer hardware and/or software, to interconnect mobile computing device 12 to network 16. Enhanced Ethernet port 14a also includes an additional function, in hardware or software, to obtain the geographic location of port 14a and supply it to mobile computing device 12 upon request, or alternately, to “push” the geographic location information for port 14a to device 12 upon connection of device 12 to port 14a. An emergency response center 20 includes a server 22 and a telephone 21. Server 22 is connected to Internet 16 via a gateway device 18, and telephone 21 is connected to Internet via a Public Switched Telephone Network (“PSTN”) 17. Server 22 processes 911 header information of calls from mobile computing device 12 via Internet 16, and a handler at telephone 21 verbally receives and responds to the voice of the caller. If desired, mobile device 12 can be moved to another location, and connected, by wire or wirelessly, to a different Enhanced Ethernet port 14b . . . n (which are similar to port 14a and connected to Internet 16 and therefore, to server 22 via gateway device 18 and to telephone 21 via PSTN 17).

Mobile computing device 12 includes a known CPU 23, operating system 24, RAM 26 and ROM 28 all on a common bus 27, and storage 32. Mobile computing device 12 also includes a known VOIP function 29, implemented in computer software and/or computer hardware. VOIP function 29 enables VOIP communications from mobile computing device 12 to other telephones (analog or VOIP) connected directly or indirectly to network 16, and vice versa. By way of example, the known VOIP function 29 can be similar to that provided by Vonage corporation or Verizon corporation. Mobile computing device 12 also includes an Enhanced Ethernet port interface function 30, implemented in computer software and/or computer hardware, according to the present invention. VOIP function 29 and Enhanced Ethernet port interface function 30 communicate with Enhanced Ethernet port 14a using H.323, MGCP, MEGACO or SIP or a proprietary protocol such as SCCP protocol. IEEE 802.11a/b/g can be used for authentication and negotiation. Function 30 queries Ethernet port 14a for the geographic location of Ethernet port 14a. Function 30 can query Ethernet port 14a to obtain the geographic location information using DHCP, BOOTP or Cisco CDP protocols (with authentication and negotiation via IEEE 802.1x). Alternately, function 30 can send a request packet with a different protocol to port 14a upon connection to port 14a, specifying the Ethernet address, IP multicast address or UDP port, and port 14a will respond with a packet containing the geographic location information. This alternate procedure could be implemented as an ICMP option pair such as Echo and Echo reply.

In one embodiment of the present invention, a technician who installed port 14a entered into port 14a the geographic location information for port 14a. In this embodiment, the technician, when installing the Ethernet port 14a, enters the geographic location of port 14a into the port 14a via a keyboard or Active RFID. The technician can learn the geographic location from a GPS unit carried by the technician, or from the actual state/city/street, floor/room number of the Ethernet port. In another embodiment of the present invention, Ethernet port 14a queries server 60 for the geographic location of port 14a because port 14a does not have the geographic location information. An administrator previously entered into server 60 the geographic location information of port 14a. Thus, if Ethernet port 14a does not contain the geographic location information for Ethernet port 14a when requested by function 30, then Ethernet port 14a will forward the request to server 60, and server 60 will return the geographic location information for port 14a. Server 60 with its central database 61, as known in the prior art, correlates each Ethernet port ID to a corresponding geographic location of the Ethernet port. Function 30 of mobile computing device 12 queries port 14a for the geographic location information of port 14a upon attachment of mobile computing device 12 to port 14a, or later, if the location information is available from server 60 if not available upon connection of mobile computing device 12 to port 14a. (If desired, function 30 can periodically confirm its geographic location by other queries to port 14a every hour.) Occasional, the location information is not available from server 60 because either server 60 is down or the communication path to server 60 is down. Function 30 receives from port 14a and stores the Ethernet Port ID and the corresponding geographic location information as a text field of state, city, street address, building number, floor, room, etc. or a GPS location. Because function 30 has received and stored the geographic location information for port 14a, when a person subsequently makes a 911 call to emergency response center 20, function 30 already has the geographic location information for port 14a, and can attach the geographic location information to the call even if server 60 is not available at the time of the 911 call.

In one embodiment of the present invention, function 30 attaches the geographic location information (received from Ethernet port 14a) to outgoing 911 VOIP telephone calls (including a digital version of the voice, and identity of the call, mobile computing device and Ethernet port 14a) sent from mobile computing device 12 via VOIP function 29 and enhanced Ethernet port 14a. In another embodiment of the present invention, when mobile computing device 12 initiates a 911 VOIP call, function 30 sends the call (including a digital version of the voice, and identity of the call, mobile computing device and Ethernet port 14a) to server 22. Also, function 30 sends the geographic location information for Ethernet port 14a and identity of the call, mobile computing device 12 and Ethernet port 14a (but not the digital version of the voice) to a call control system 15 connected to Internet 16. In response, call control system 15 sends the geographic location information for Ethernet port 14a/mobile computing device 12 to emergency response center server 22 along with the identification of the call, mobile computing device 12 and Ethernet port 14a. This allows the server 22 to correlate the geographic location information with the call, and thereby determine the geographic location of the call.

Thus, the Enhanced Ethernet port interface 30 will combine the Ethernet port ID and corresponding geographic location information with each 911 call made by mobile device 12 to the emergency response center 20. Optionally, the Enhanced Ethernet port interface function 30 will combine the Ethernet port ID and corresponding geographic location information with all calls made by mobile device 12 to any destination. Thus, mobile computing device 12 will automatically supply its geographic location information to the emergency call center 20, so the emergency call center does not have to query the central server 60 with its central database 61 (which may be unavailable) or ask the user verbally over the telephone.

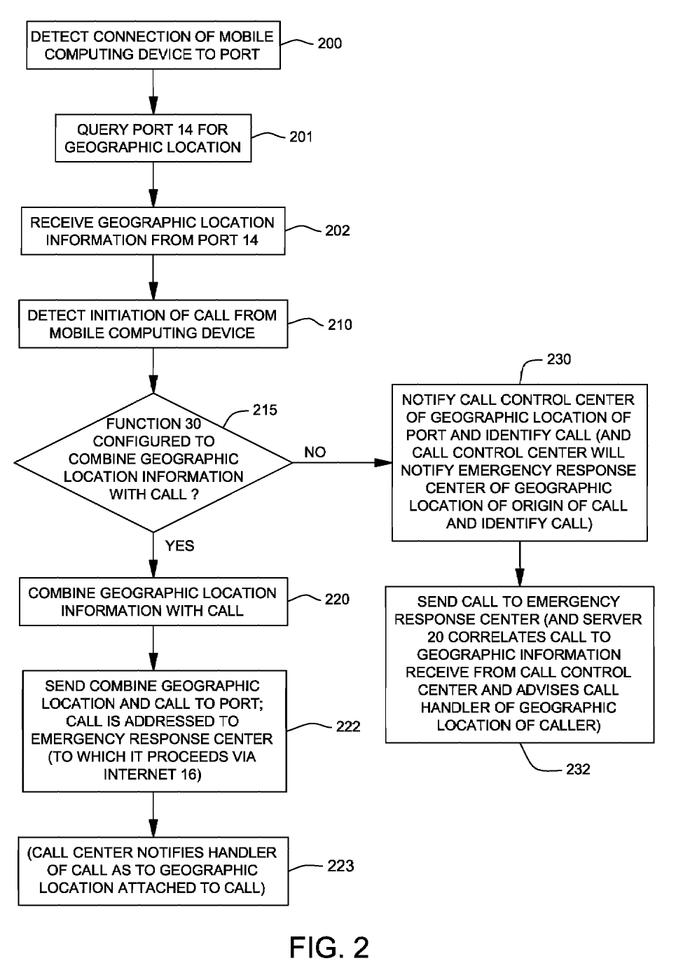

FIG. 2 illustrates programming within Enhanced Ethernet port interface function 30. Function 30 detects connection (by wire or wirelessly) of mobile computing device 12 to port 14a (step 200). In response to connection of mobile computing device 12 to Ethernet port 14a, function 30 queries Ethernet Port 14a for an identification of Ethernet port 14a and information as to the geographic location of Ethernet port 14a (step 201). (Alternately, Ethernet port 14a can “push” the information to function 30 upon connection of mobile computing device 12 to port 14a.) Port 14a either has the geographic location information already stored in its storage 16a or obtains the geographic location information by query to server 60. In response to receipt of the geographic location information from port 14a and identity of port 14a, function 30 stores in file 31 the identification of Ethernet port 14a and the information as to the geographic location of Ethernet 14a (step 202). Sometime later, a user of mobile computing device 12 initiates a 911 VOIP telephone call. Function 30 detects that the user has initiated a 911 VOIP telephone call from mobile computing device 12 (step 210), and in response, (a) combines the geographic location information with the call (step 220), or (b) notifies call control system 15 of the geographic location information along with an identification of the call, Ethernet port 14a and mobile computing device 12 (step 230), depending on the configuration of function 30. In the former case (a) where function 30 combines the geographic location information with the call, function 30 forwards the call (including the spoken words of the call in digital form, and an identification of the call, mobile computing device 12 and Ethernet port 14a) to telephone 21 and server 22 at call center 20 (step 222). The call proceeds to server 22 via Internet 16, and gateway device 16. The call proceeds to telephone 21 via Internet 16 and PSTN 17. In the latter case (b) where function 30 notifies call control system 15 of the geographic location information along with an identification of the call, mobile computing device 12 and Ethernet port 14a, function 30 forwards the spoken words of the call in digital form to telephone 21 via Internet 16 and PSTN 17 (step 232). In the latter case (b), the call control system 15 will forward to server 20 the geographic location information of mobile computing device 12 along with an identification of the call, mobile computing device 12 and Ethernet port 14a. In response, the server 20 correlates the current call being received at telephone 21 to the geographic location information for the mobile computing device 12 from which the call originated (by matching the identification of the call, mobile computing device 12 and Ethernet port 14a as received from the mobile computing device 12 and call control system 15. In either case, the emergency response center 20 will then notify an operator of the geographic location of the caller (step 223), and the operator can forward this information to a police, fire, or rescue unit, as appropriate for the nature of the emergency.

Function 30, to the extent implemented as a computer program, can be loaded into mobile computing device 12 from a computer readable media 85 such as magnetic tape or disk, optical media, DVD, memory stick, semiconductor memory, etc. or downloaded from Internet 16 via TCP/IP adapter card 90.

The additional function within Enhanced Ethernet port 14a that supplies the geographic location information of port 14a to device 12, to the extent implemented as a computer program, can be loaded into port 14a from a computer readable media 86 such as magnetic tape or disk, optical media, DVD, memory stick, semiconductor memory, etc. or downloaded from Internet 16 via TCP/IP adapter card 91.

Based on the foregoing, a system, method and program product have been disclosed for conveying to an emergency response center server the geographic location of a mobile computing device. However, numerous modifications and substitutions can be made without deviating from the scope of the present invention. For example, function 30 can also attach the information describing the geographic location of Ethernet port 14a/mobile communication device 12 to other types of communications (such as e-mail, instant messages, etc.) sent from device 12 to any destination. Also, Ethernet port management server 60 or other asset tracking server, not shown, can periodically send an SNMP query to all Ethernet ports 14a, b . . . n to track devices connected to the Ethernet ports 14a, b . . . n, and in response, the Ethernet ports 14a, b . . . n will forward the queries to their respective attached devices including mobile computing device 12. Mobile computer device 12 will then return the identification of mobile computing device 12, Ethernet Port ID and geographic location to server 60 or other asset tracking server via Ethernet port 14a, b . . . n.) Therefore, the present invention has been disclosed by way of illustration and not limitation, and reference should be made to the following claims to determine the scope of the present invention.

What is claimed:

1. A method for managing VOIP calls from a mobile computing device, said mobile computing device being connected, by wire or wirelessly, to a network port device, said method comprising the steps of:
said mobile computing device receiving from said network port device information describing a geographic location of said network port device; and
said mobile computing device sending a VOIP call, and including with said VOIP call, information describing said geographic location of said network port device.

2. A method as set forth in claim 1 wherein the step of said mobile computing device receiving from said network port device the geographic location of said network port device is performed in response to the connection of said mobile computing device to said network port device.

3. A method as set forth in claim 1 wherein said mobile computing device sends said VOIP call to a server.

4. A method as set forth in claim 3 wherein, prior to said mobile computing device being connected to said network port device, said network port device receiving from another server said information describing the geographic location of said network port device.

5. A method as set forth in claim 1 wherein said call is a 911 call, or similar type of call in another country outside the United States of America.

6. A method as set forth in claim 1 wherein said network port device is an Ethernet port device.

7. A mobile computing device for managing VOIP calls from a mobile computing device, said mobile computing device being connected, by wire or wirelessly, to a network port device, said mobile computing device comprising:
means for receiving from said network port device information describing a geographic location of said network port device; and
means for sending a VOIP call, and including with said VOIP call, information describing said geographic location of said network port device.

8. A mobile computing device as set forth in claim 7 wherein the means for receiving from said network port device the geographic location of said network port device is performed in response to the connection of said mobile computing device to said network port device.

9. A mobile computing device as set forth in claim 7 wherein said means for sending sends said VOIP call to a server.

10. A mobile computing device as set forth in claim 9 wherein, prior to said mobile computing device being connected to said network port device, said network port device receiving from another server said information describing the geographic location of said network port device.

11. A mobile computing device as set forth in claim 7 wherein said call is a 911 call, or similar type of call in another country outside the United States of America.

12. A mobile computing device as set forth in claim 7 wherein said network port device is an Ethernet port device.

13. A method for managing VOIP calls from a mobile computing device to a first server, said mobile computing device being connected, by wire or wirelessly, to a network port device, said method comprising the steps of:
said mobile computing device receiving from said network port device information describing a geographic location of said network port device;
said mobile computing device sending a VOIP call to said first server, and including with said VOIP call, information identifying said call, said network port device and/or said mobile computing device, and sending to a second server information identifying said call, said network port device and/or said mobile computing device, and information describing said geographic location of said network port device;
said second server forwarding to said first server said information identifying said call, said network port device and/or said mobile computing device, and said information describing said geographic location of said network port device; and
said first server correlating said VOIP call received from said mobile computing device with the geographic location information provided by said second server, and notifying an operator as to the geographic location of said mobile computing device.

14. A method as set forth in claim 13 wherein the step of said mobile computing device receiving from said network port device the geographic location of said network port device is performed in response to the connection of said mobile computing device to said network port device.

15. A method as set forth in claim 13 wherein said call is a 911 call, or similar type of call in another country outside the United States of America.

16. A method as set forth in claim 13 wherein, prior to said mobile computing device being connected to said network port device, said network port device receiving from another server said information describing the geographic location of said network port device.

17. A method as set forth in claim 13 wherein said network port device is an Ethernet port device.
